(19) United States
(12) Patent Application Publication
(10) Pub. No.: US 2020/0296549 A1
(43) Pub. Date: Sep. 17, 2020

(54) MOVING BODY STATE IDENTIFICATION SYSTEM AND METHOD

(71) Applicant: Panasonic Corporation, Osaka (JP)

(72) Inventors: HIROYUKI TANI, Hyogo (JP); TAKUMA IKEDA, Osaka (JP)

(21) Appl. No.: 16/792,661

(22) Filed: Feb. 17, 2020

(30) Foreign Application Priority Data
Mar. 13, 2019 (JP) 2019-046003

(51) Int. Cl. H04W 4/029; H04B 17/318

(52) U.S. Cl. CPC H04W 4/029; H04B 17/318

(57) ABSTRACT

A moving body state identification system acquires identified information of a moving body by using a small terminal that does not need to charge or replace a battery. The moving body state identification system includes a transceiver that transmits radio waves and wirelessly receives a signal, ID tags that receive the radio waves, convert the received radio waves into power, and use the power as a power supply to transmit unique ID information to the transceiver, and a state information transmitter that is attached to a moving body, receives the radio waves, converts the received radio waves into power, and uses the power as a power supply to transmit state information about a state of the moving body to the transceiver. The transceiver identifies the moving body based on the ID information and the state information.

### TECHNICAL FIELD

The technical field relates to a moving body state identification system.

### BACKGROUND

In recent years, attention has been paid to efforts to improve work efficiency by collecting a position or motion line information of a person with advancement of IoT. For example, JP-A-2001-183455 (Patent Literature 1) proposes a moving body position measuring system using ID tags that can communicate with each other at a short indoor distance to detect a position of a person or the like.

The moving body position measuring system proposed in Patent Literature 1 is provided with a plurality of ID tags having unique ID information on the floor, and an ID reader attached to a moving body reads information of an adjacent ID tag. Patent Literature 1 discloses a technique for measuring the presence of the moving body at a position where an ID tag whose ID tag information is read is disposed and measuring a direction of the moving body based on a vector direction.

However, since the moving body position measuring system in the related art uses the ID reader, the moving body position measuring system is used only when a position at a relatively short indoor distance or the like is measured. In order to measure a position at a long distance, it is necessary to carry a wireless device having a long-distance information communication function such as a mobile phone or a smart phone. The wireless device needs to be a device that is authenticated by the Radio Act. Many large devices may be difficult to carry all the time. In addition, it is necessary to replace or periodically charge a battery in order to drive the battery.

### SUMMARY

An object of the present disclosure is to provide a moving body state identification system and a moving body state identification method by using a small terminal that does not need to charge or replace a battery.

The moving body state identification system according to the present disclosure includes a transceiver configured to transmit radio waves and wirelessly receive a signal, ID tags configured to receive the radio waves, convert the received radio waves into power, and use the power as a power supply to transmit unique ID information to the transceiver, and a state information transmitter attached to a moving body, configured to receive the radio waves, convert the received radio waves into power, and use the power as a power supply to transmit state information about a state of the moving body to the transceiver.

The moving body state identification method according to the present disclosure includes a step of a transceiver transmitting a radio wave, a step of ID tags receiving the radio wave, converting the received radio wave into power, and using the power as a power supply to transmit unique ID information to the transceiver, a step of a state information transmitter that is attached to a moving body receiving the radio wave, converting the received radio wave into power, and using the power as a power supply to transmit state information about a state of the moving body to the transceiver, and a step of the transceiver identifying the moving body based on the ID information and the state information.

The moving body state identification system according to the present disclosure can identify a state of a moving body without using a wireless device that needs to replace or charge a battery.

### BRIEF DESCRIPTION OF THE DRAWINGS

FIG. 1 is a diagram showing a human body position detection system according to an embodiment.

FIG. 2 is a diagram showing a configuration of the human body position detection system according to the embodiment.

FIG. 3 is a diagram showing a configuration of a state information transmitter according to the embodiment.

FIG. 4 is a diagram showing a configuration of the state information transmitter using a common antenna according to the embodiment.

FIG. 5 is a diagram showing a state in which a plurality of ID tags are provided according to another embodiment.

### DESCRIPTION OF EMBODIMENTS

An embodiment of the present disclosure will be described with reference to the drawings. A moving body in the present specification is a concept including an airborne object such as a vehicle, a flying body, and an advertising balloon, a human body, an animal, and the like. Hereinafter, an example suitable for a moving body, especially a human body, will be described in the present embodiment.

### <Configuration>

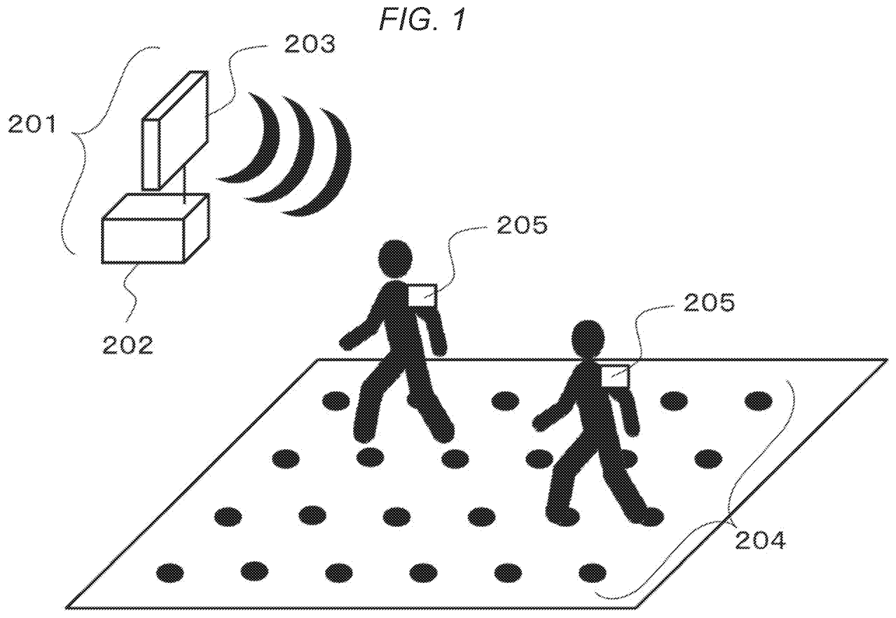

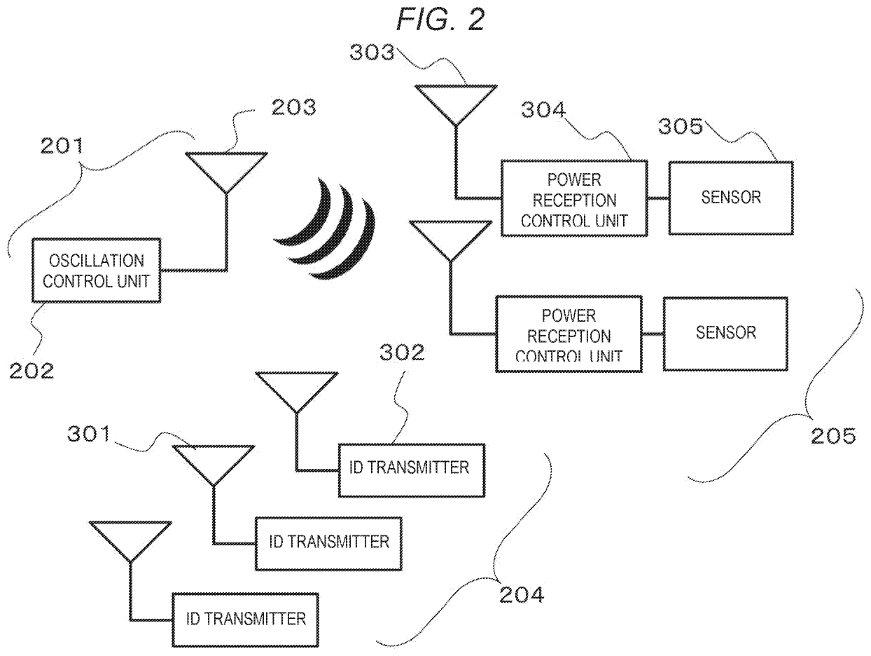

FIGS. 1 and 2 show a moving body state identification system according to the present embodiment. The moving body state identification system includes a transceiver 201, ID tags 204 that detect a position of a human body which serves as a moving body, and state information transmitters 205 which serve as an example of a sensor that detects a state of the human body which serves as a moving body. Next, configurations will be described in detail.

### <Transceiver 201>

The transceiver 201 has a function of generating high frequency power and emitting the high frequency power to a space as radio waves. The transceiver 201 has a function of transmitting the radio waves to instruct the ID tags 204 and the state information transmitters 205 to transmit information, and acquiring information from the ID tags 204 and the state information transmitters 205. The transceiver 201 includes an oscillation control unit 202 and an antenna 203.

### <Oscillation Control Unit 202>

The oscillation control unit 202 has a function of generating high frequency power. The oscillation control unit 202 is implemented by an electrical circuit such as a crystal oscillator, a phase lock loop (PLL), and an amplifier circuit (AMP), and generates high frequency power. A frequency of the generated high frequency power is not particularly limited as long as the frequency of the generated high frequency power is in a microwave band such as a 900 MHz band, a 2.45 GHz band, and a 5.8 GHz band. The generated high frequency power is selected according to a power transmission distance, a size of the transceiver, and the like.

The oscillation control unit 202 generates the high frequency power as radio waves and controls transmission and reception of the radio waves. The oscillation control unit 202 acquires and stores information transmitted from the ID tags 204 and the state information transmitters 205 which will be described later. Based on the acquired information, the oscillation control unit 202 calculates information that identifies a person who carries the state information transmitter 205. The oscillation control unit 202 includes an electrical circuit such as a memory, a CPU, a communication device, and a functional device.

### <Antenna 203>

The antenna 203 has a function of transmitting the high frequency power generated by the oscillation control unit 202 to a space as radio waves, a function of receiving radio waves emitted from other devices (from the ID tags 204 and the state information transmitters 205 in the present embodiment), and a function of transmitting radio waves to instruct other devices.

Antenna types are broadly classified into a directional antenna and a non-directional antenna. A directional antenna is used, for example, when power is to be transmitted in a narrow range and for a long distance in a certain direction. A non-directional antenna is used, for example, when power is to be transmitted in a relatively wide range and for a short distance.

The directional antenna has a planar structure, and is, for example, a patch antenna having a structure in which a dielectric substrate is interposed between a GND plate and an antenna plate. The non-directional antenna has a linear structure, and is, for example, a dipole antenna or a monopole antenna in which a conductive wire or the like that carries electricity is linearly extended.

### <ID Tag 204>

The ID tags 204 includes antennas 301 and ID transmitters 302. Each of the ID tags 204 receives radio waves emitted from the transceiver 201 via the respective antenna 301, converts the received radio waves into power, and uses the power as a power supply to transmit held ID information to the transceiver 201. It is preferable to provide a plurality of ID tags 204 in order to identify a personal operation to be described below. As shown in FIG. 1, it is preferable to provide the plurality of ID tags 204 on for example, a floor surface or on a wall surface, in a direction in which the ID tags 204 can be clearly seen and a human body is easily detected. The ID information held by the ID tag 204 includes position information necessary for identifying a position of the ID tag 204. For example, coordinates such as latitude and longitude of the position information may be stored in advance and held by the ID tag 204 when the ID tag 204 is provided. In a case where the ID tag 204 is provided in a moving unit such as a passenger ship, a position of the ID tag 204 may change due to a movement of the passenger ship. In this case, the ID tag may include a GPS device or the like, and position information from the GPS device may be updated and held for each movement.

### <State Information Transmitter 205>

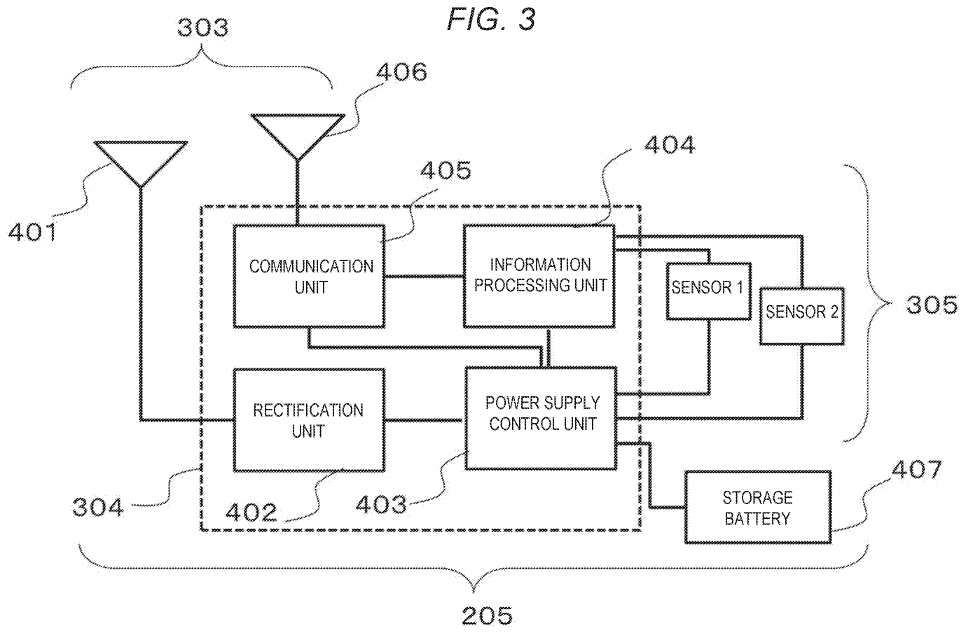

FIG. 3 shows the state information transmitter 205 according to the present embodiment. The state information transmitter 205 includes a sensor 305, a power reception antenna 401, a rectification unit 402, a power supply control unit 403, an information processing unit 404, a communication unit 405, a communication antenna 406, and a storage battery 407. The state information transmitter 205 receives radio waves emitted from the transceiver 201, converts the received radio waves into power, and uses the power as a power supply. The state information transmitter 205 transmits, to the transceiver 201, personal ID information of a person to whom the state information transmitter 205 is attached and state information about a state of the person that is acquired by the sensor 305. The personal ID information includes information for identifying a person to whom the state information transmitter 205 is attached, such as name, age, and address of the person. The information for identifying the person to whom the state information transmitter 205 is attached is not limited to name, age, address, and the like of the person. The state information transmitter 205 may include a so-called wearable sensor having a communication function. The state information transmitter 205 further includes a power reception control unit 304. Since the power reception control unit 304 includes the rectification unit 402, the power supply control unit 403, the information processing unit 404, and the communication unit 405, and the number of the power reception control unit 304 is two, each unit will be described below.

### <Sensor 305>

The state information acquired by the sensor 305 includes various pieces of information such as biological information. The sensor 305 may include various sensors in accordance with information to be acquired. For example, in a case where acquired information is used for nursing care, since it is necessary to acquire motion information in order to prevent a fall accident or the like, it is preferable to use, for example, an acceleration sensor. When information to be acquired is about health, for example, a body temperature sensor or a heart rate sensor may be used. The sensor 305 is not limited to those described above and various sensors may be used. The number of the sensor 305 is not limited to one, and a plurality of sensors 305 may be used in accordance with information to be acquired.

### <Power Reception Antenna 401 to Storage Battery 407>

The power reception antenna 401 receives high frequency power (radio waves) emitted from the transceiver 201. The rectification unit 402 converts the received power into a direct current. The power supply control unit 403 supplies the direct current to the sensor 305, the information processing unit 404, and the communication unit 405, and charges the storage battery 407 with surplus power. When the received power is small and power required for operating a system cannot be received, the power supply control unit 403 supplies power stored in the storage battery 407 to the information processing unit 404 and the communication unit 405. The communication antenna 406, and the communication unit 405 exchange information with the transceiver 201. The communication antenna 406 and the communication unit 405 transmit ID information, information acquired by the sensor 305, and charge amount information of the storage battery 407 to the transceiver 201. The communication antenna 406 receives an instruction of radio waves from the transceiver 201.

Even when high frequency power is not supplied from the transceiver 201, the information processing unit 404 uses power stored in the storage battery 407 to process information acquired by the sensor 305, and transmits the information acquired by the sensor 305 via the communication unit 405 for a constant time. Since a type of antennas used for the power reception antenna 401 and the communication antenna 406 is similar to a type of the antenna 203 of the transceiver 201, a description thereof will be omitted.

### <Human Body Position Detection Operation>

Next, a method for detecting a human body will be described.

A reference intensity of radio waves emitted from the ID tags 204 is determined before the human body is actually detected. Specifically, the transceiver 201 transmits radio waves and instructs the ID tags 204 to transmit ID information in a state in which the human body is not present in the vicinity of the ID tags 204. Then, each ID tag 204 transmits the ID information to the transceiver 201. Thereafter, the transceiver 201 receives the ID information, and the oscillation control unit 202 associates each piece of the ID information with an intensity of the received radio waves and stores the intensity of the received radio waves into a memory provided in the oscillation control unit 202. The oscillation control unit 202 identifies positions of the ID tags 204 based on the ID information received from the ID tags 204, and determines an intensity of the radio waves received at this time as a reference intensity.

After preparation is performed in such a manner in advance, an actual detection of a human body is performed as follows.

(1) The transceiver 201 transmits radio waves and instructs the ID tags 204 to transmit ID information.

(2) Each ID tag 204 transmits ID information to the transceiver 201.

(3) The transceiver 201 reads a reference intensity corresponding to the ID information received from the ID tags 204 from the memory provided in the oscillation control unit 202, and compares the read reference intensity with an intensity of radio waves received from the ID tags 204.

(4) Whether a human body is present in the vicinity of the ID tags 204 is detected based on a change in the intensity of the received radio waves relative to the reference intensity.

When a human body is present in the vicinity of the ID tags 204, radio waves emitted from the ID tags 204 are blocked by the human body. As a result, an intensity of radio waves received by the transceiver 201 is low. Whether a human body is present in the vicinity of the ID tag 204 can be detected using this principle.

The oscillation control unit 202 may set an amount of change relative to the reference intensity as a threshold in advance, and may determine that a human body is present when, for example, an intensity of received radio waves is lowered to 50% or less of the reference intensity. The threshold is not limited to 50% of the reference intensity, and may be, for example, 60% or 40% of the reference intensity. Even when the radio waves cannot be received and the ID information cannot be read, the oscillation control unit 202 may determine that an intensity of the radio waves is equal to or less than the threshold. According to this method, the ID tag 204 of which a human body is present in the vicinity can be identified among the plurality of ID tags 204.

### <Personal Identification Operation>

A method for identifying a detected human body will be described.

(1) The transceiver 201 transmits an instruction to instruct the state information transmitter 205 to transmit state information.

(2) The state information transmitter 205 transmits personal ID information and state information acquired by the sensor 305 to the transceiver 201.

(3) The oscillation control unit 202 receives the personal ID information and the state information acquired by the sensor 305, and stores the state information and an intensity of received radio waves into the memory provided in the oscillation control unit 202. Here, the oscillation control unit 202 can estimate a distance between the transceiver 201 and the state information transmitter 205 based on an intensity of the radio waves acquired from the state information transmitter 205. The transceiver 201 can identify a presence range in which the state information transmitter 205 is present based on the estimated distance. As described above, the transceiver 201 identifies the ID tag 204 in the vicinity of the human body. In addition, the transceiver 201 can detect a position of a moving body in detail by identifying the ID tag 204 based on the intensity of the radio waves acquired from the state information transmitter 205.

(4) The transceiver 201 can identify a personal state (a state of the moving body) such as a human body temperature and a heart rate by associating information (personal ID information and state information) from the state information transmitter 205 with a human body position that is detected based on the presence range of the state information transmitter 205 and a reception intensity of radio waves transmitted from the ID tag 204.

For example, when a large number of state information transmitters 205 are close to each other or when a direction of an antenna 303 (the power reception antenna 401 or the communication antenna 406) of the state information transmitter 205 is not appropriate, it may be difficult to identify a person according to the personal ID information from the state information transmitter 205 only. In such a case, the sensor 305 preferably includes an acceleration sensor such that a person can be identified based on information from the state information transmitter 205. When the sensor 305 includes an acceleration sensor, the transceiver 201 transmits the personal ID information and motion information (state information) obtained by the acceleration sensor in a state in which the motion information is associated with the personal ID information. Then, the transceiver 201 acquires the personal ID information and the motion information in a state in which the personal ID information and the motion information are associated with each other. In this manner, for example, even when a large number of state information transmitters 205 are present at the same position, the transceiver 201 can compare and distinguish directions in which persons move and timings when persons move based on the motion information, and at the same time, can distinguish personal ID information associated with the motion information. Therefore, the transceiver 201 can identify the state information transmitter 205 where the motion is performed from a large number of state information transmitters 205, and thus can identify a person.

As described above, although the present embodiment describes an example in which the human body is the moving body, the moving body is not limited to a human body. When the moving body is not a human body, state information includes the following matters. When the moving body is, for example, a vehicle, state information may include a weight of a load, a position of the load, a temperature of the load, and the number of occupants. When the moving body is, for example, an airborne object such as an advertising balloon, state information may include a temperature of the moving body, a temperature around the moving body, an atmospheric pressure around the moving body, and the like.

### (Modification of State Information Transmitter 205)

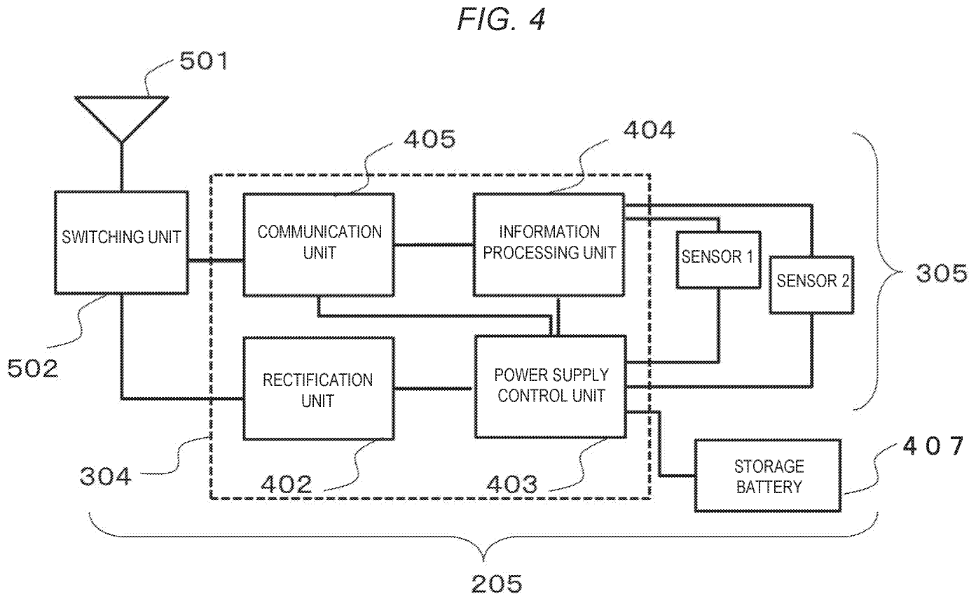

FIG. 4 shows the state information transmitter 205 according to another embodiment. The state information transmitter 205 according to the present embodiment is different from the state information transmitter 205 according to the previous embodiment in that a common antenna 501 and a switching unit 502 are provided instead of the power reception antenna 401 and the communication antenna 406. Here, the difference from the state information transmitter 205 according to the previous embodiment will be described, and a description of the same portions will be omitted.

### <Common Antenna 501>

The common antenna 501 can be used by switching an input and an output between at the time of power reception and at the time of communication if frequencies of radio waves to be used are the same at the time of receiving high frequency power (electromagnetic waves) from the transceiver 201 and at the time of communicating with the transceiver 201. Even if the frequencies of the radio waves described above are different, input and output can be switched by the switching unit 502 to use the antenna 501 when the difference is several percentages (for example, 2% to 5%) of the frequencies. The switching unit 502 switches a connection between the antenna 501 and the communication unit 405 and a connection between the antenna 501 and the rectification unit 402 according to the needs. Specifically, for example, when high frequency power that is emitted from the transceiver 201 is received, the switching unit 502 connects the antenna 501 with the rectification unit 402 and cuts off the connection between the antenna 501 and the communication unit 405. On the contrary, for example, when the information processing unit 404 transmits information to the transceiver 201 via the communication unit 405, the switching unit 502 connects the antenna 501 with the communication unit 405 and cuts off the connection between the antenna 501 and the rectification unit 402. In this manner, by using the common antenna 501 instead of the two antennas, that is, the power reception antenna 401, and the communication antenna 406, a degree of design freedom when designing, for example, an installation space or a direction of the antenna, is achieved.

It is preferable that the power reception antenna 401, the communication antenna 406, and the antenna 501 have an appropriate shape in accordance with a state in which the state information transmitter 205 is worn by a human body or the like. For example, when the state information transmitter 205 is placed in a pocket, when the state information transmitter 205 is wrapped around an arm or a leg, when the state information transmitter 205 is sewed on clothing, and when the state information transmitter 205 is directly pasted on a human body like a plaster, an antenna having an appropriate shape is used in accordance with a wearing portion of the state information transmitter 205 or a shape of the state information transmitter 205. Since a type of antennas used for the common antenna 501 is similar to the type of the antenna 203 of the transceiver 201, the power reception antenna 401, and the communication antenna 406, a description thereof will be omitted.

### <ID Tag 204>

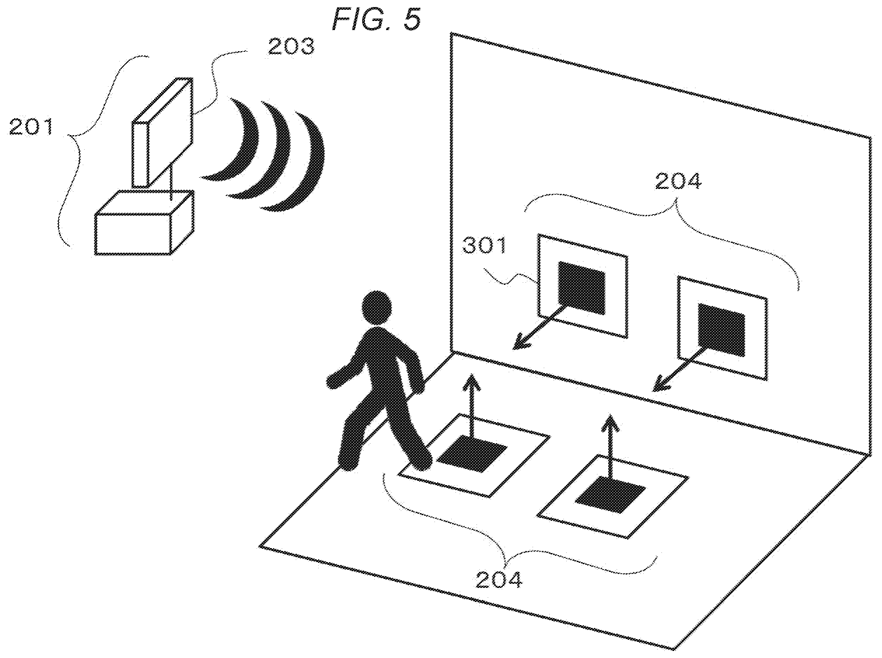

FIG. 5 shows a state of providing a plurality of ID tags 204 according to another embodiment. The ID tag 204 is provided, for example, on a floor surface and a wall surface formed upright from the floor surface. Since the antenna 301 of the ID tag 204 is the above-described directional antenna, a direction of a directivity of the antenna 301 is perpendicular to the floor surface and the wall surface on which the ID tag 204 is provided. Therefore, when a human body approaches the antenna 301 of the ID tag 204, the human body can be detected in two directions from the floor surface and the wall surface, and a position of the human body can be identified in more detail than in one direction.

### <Effect>

A position of a human body can be detected using the ID tag 204 without needing a wireless device that needs to charge or replace a battery. In addition, a personal state can be identified using the state information transmitter 205.

The moving body state identification system according to the present disclosure can be widely used as a system to acquire information that identifies a position of a moving body.

What is claimed is:

1. A moving body state identification system comprising:
a transceiver configured to transmit a radio wave and wirelessly receive a signal;
a plurality of ID tags, each configured to receive the radio wave, convert the received radio wave into power, and use the power as a power supply to transmit unique ID information to the transceiver; and
a state information transmitter that is attached to a moving body and configured to receive the radio wave, convert the received radio wave into power, and use the power as the power supply to transmit state information about a state of the moving body to the transceiver, wherein
the transceiver identifies a state of the moving body based on the ID information and the state information.

2. The moving body state identification system according to claim 1, wherein
the transceiver detects whether the moving body is present in a vicinity of the ID tags based on a predetermined reference intensity and an intensity of radio waves received from the ID tags.

3. The moving body state identification system according to claim 2, wherein
the transceiver detects a position of the moving body based on a reception intensity of radio waves transmitted from the state information transmitter and a reception intensity of radio waves transmitted from the ID tags.

4. The moving body state identification system according to claim 3, wherein
the state information includes acceleration information of the moving body, and
the transceiver identifies a state of the moving body based on the acceleration information and the reception intensity of radio waves transmitted from the ID tags.

5. The moving body state identification system according to claim 1, wherein
the state information transmitter includes a power reception antenna and a communication antenna,
the power reception antenna receives the radio wave that is used for power and transmitted from the transceiver, and
the communication antenna transmits the state information to the transceiver.

6. The moving body state identification system according to claim 5, wherein
the power reception antenna and the communication antenna are a common antenna, and a switching unit performs switching between at a time of power reception and at a time of communication.

7. The moving body state identification system according to claim 1, wherein
the ID tags have position information necessary for identifying positions of the ID tags, and transmit the position information to the transceiver.

8. The moving body state identification system according to claim 1, wherein
each of the ID tags includes an antenna and an ID transmitter, and
each of the ID tags receives the radio wave emitted from the transceiver via the respective antenna, converts the received radio wave into power, and uses the power as a power supply to transmit the respective position information to the transceiver.

9. The moving body state identification system according to claim 1, wherein
the information transmitter includes a sensor and a communication unit,
the state information transmitter receives the radio wave emitted from the transceiver, converts the received radio wave into power, and uses the power as a power supply, and
the state information transmitter transmits personal ID information of a person to whom the state information transmitter is attached and state information about a state of the person that is acquired by the sensor to the transceiver via the communication unit.

10. A moving body state identification method comprising:
a step of a transceiver transmitting a radio wave;
a step of an ID tag receiving the radio wave, converting the received radio wave into power, and using the power as a power supply to transmit unique ID information to the transceiver;
a step of a state information transmitter that is attached to a moving body receiving the radio wave, converting the received radio wave into power, and using the power as a power supply to transmit state information about a state of the moving body to the transceiver; and
a step of the transceiver identifying the moving body based on the ID information and the state information.
